(19) United States
(12) Patent Application Publication
(10) Pub. No.: US 2016/0057231 A1
(43) Pub. Date: Feb. 25, 2016

(54) Avoiding Registration Storms for Open Systems Interconnection Layer 4 Through Layer 7 Services in a Cloud Computing System

(71) Applicant: AT&T Intellectual Property I, L.P., Atlanta, GA (US)

(72) Inventors: Anisa Parikh, Holmdel, NJ (US); Neela R. Atluri, Marlboro, NJ (US); Paritosh Bajpay, Edison, NJ (US); Sekar Ganesan, Ocean, NJ (US); Shobhna Goyal, Marlboro, NJ (US); Shiv Kumar, Marlboro, NJ (US); Magda K. Nassar, Tinton Falls, NJ (US); Satyendra Tripathi, E Brunswick, NJ (US); Ralph Utano, Fair Haven, NJ (US)

(73) Assignee: AT&T Intellectual Property I, L.P., Atlanta, GA (US)

(21) Appl. No.: 14/464,222

(22) Filed: Aug. 20, 2014

(51) Int. Cl. H04L 29/08; H04L 12/801; G06F 17/30

(52) U.S. Cl. CPC H04L 67/14; G06F 17/30575; H04L 47/12

(57) ABSTRACT

Concepts and technologies disclosed herein are directed to avoiding registration storms for Open Systems Interconnection (“OSI”) communication model layers 4-7 services in a cloud computing system. According to one aspect of the concepts and technologies disclosed herein, a traffic distribution system can receive a connection request from a device. The traffic distribution system also can send the connection request to a site. The site can include a virtual call session control function (“V-CSCF”). The site also can include a state persistence database. The V-CSCF can cause a registration state associated with the device to be stored in the state persistence database. The registration state can be replicated to one or more further persistence databases that operate within one or more further sites.

### BACKGROUND

Today, the registration and presence states of users are tightly coupled to network functions and are not replicated across disaster recovery sites. In case of a site failure, the registration/presence state of the users is lost. In response, all user devices that were registered at the failed site must re-register and re-publish their presence information. The influx of connections and presence updates causes a registration storm at the disaster recovery site, thereby increasing the risk of failures at the disaster recovery site due to the additional load. As a preventative measure, some sites may be over-dimensioned to handle capacity needed during registration/presence storms. This excess capacity is not needed during normal operations.

### SUMMARY

Concepts and technologies disclosed herein are directed to avoiding registration storms for Open Systems Interconnection (“OSI”) communication model layers 4-7 services in a cloud computing system. According to one aspect of the concepts and technologies disclosed herein, a traffic distribution system can receive a connection request from a device. The traffic distribution system also can send the connection request to a site. The site can include a virtual call session control function (“V-CSCF”). The site also can include a state persistence database. The V-CSCF can cause a registration state associated with the device to be stored in the state persistence database. The registration state can be replicated to one or more further state persistence databases that operate within one or more further sites.

In some embodiments, the traffic distribution system can receive the connection request from the device via an evolved packet core (“EPC”). In some embodiments, the traffic distribution system resides within the evolved packet core. In some other embodiments, the traffic distribution system is in communication with the evolved packet core.

In some embodiments, the traffic distribution system can detect that the site has failed. The traffic distribution system also can receive a session request from the device. In response to receiving the session request after the site has failed, the traffic distribution system can send the session request to a further virtual call session control function that operates within a further site. The traffic distribution system can detect that the site has failed based, at least in part, upon site monitoring mechanism. For example, the traffic distribution system can detect that the site has failed in response to receiving a number of connection requests for the site beyond a threshold number of connection requests that the site is capable of handling. The session request can be for a service that operates within one of layer 4 through layer 7 of the OSI communication model.

According to another aspect of the concepts and technologies disclosed herein, a cloud computing system can include a first site, a second site, and a traffic distribution system. The first site can include a first V-CSCF and a first state persistence database. The second site can include a second V-CSCF and a second state persistence database. The traffic distribution system can receive a connection request from a device. The traffic distribution system can send the connection request to the first site. The first V-CSCF of the first site can cause a registration state associated with the device to be stored in the first state persistence database. The first state persistence database can replicate the registration state to the second state persistence database.

In some embodiments, the traffic distribution system can detect that the first site has failed. The traffic distribution system also can receive a session request from the device. In response to receiving the session request after the first site has failed, the traffic distribution system can send the session request to the second V-CSCF. The traffic distribution system can detect that the site has failed based, at least in part, upon site monitoring mechanism. For example, the traffic distribution system can detect that the site has failed in response to receiving a number of connection requests for the site beyond a threshold number of connection requests that the site is capable of handling. In some embodiments, the cloud computing system can include a third site. The third site can include a third V-CSCF and a third state persistence database. The first state persistence database also can replicate the registration state to the third state persistence database.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of operating environment for implementing the various concepts and technologies disclosed herein.

FIG. 2 is a flow diagram illustrating aspects of a method for avoiding registration storms for Open Systems Interconnection (“OSI”) communication model layer 4 through layer 7 services in a cloud computing system, according to an illustrative embodiment.

FIG. 3 is a block diagram illustrating an example mobile device capable of implementing aspects of the embodiments disclosed herein.

FIG. 4 is a block diagram illustrating an example computer system capable of implementing aspects of the embodiments presented herein.

FIG. 5 is a diagram illustrating a network, according to an illustrative embodiment.

### DETAILED DESCRIPTION

Concepts and technologies disclosed herein are directed to avoiding registration storms for Open Systems Interconnection (“OSI”) communication model layers 4-7 services in a cloud computing system. While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, mobile devices, wireless devices, multiprocessor systems, distributed computing systems, microprocessor-based or programmable consumer electronics, minicomputers, mainframe computers, routers, switches, other computing devices described herein, and the like.

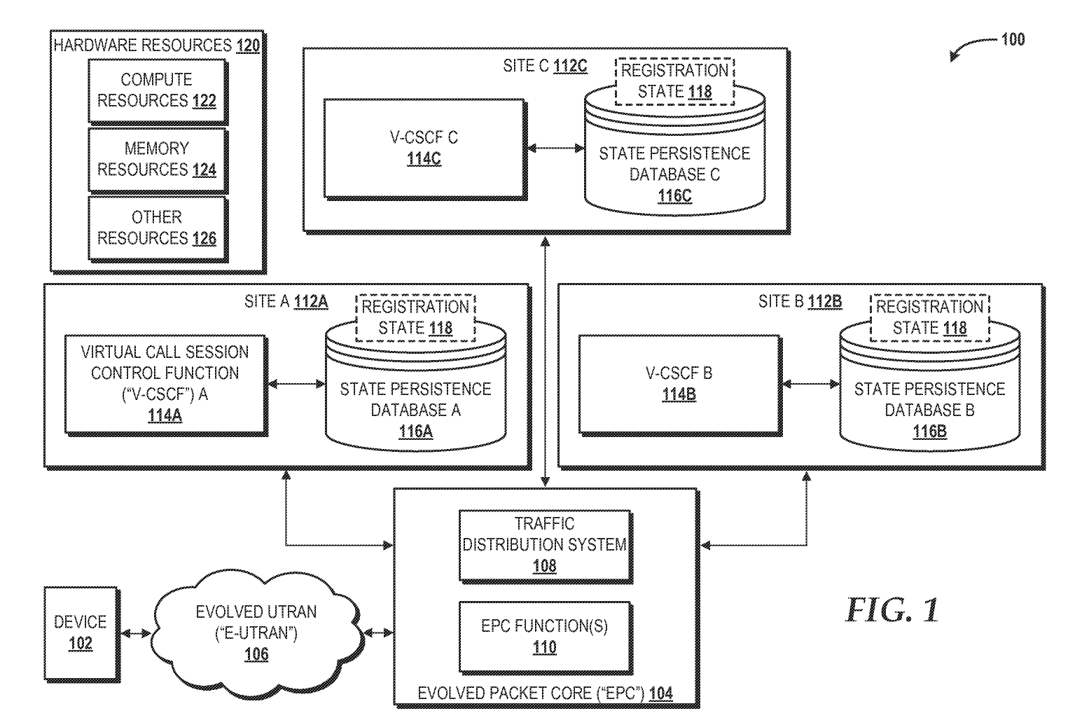

Referring now to FIG. 1, a block diagram illustrating aspects of an operating environment 100 for implementing the various concepts and technologies disclosed herein will be described. The illustrated operating environment 100 includes a device 102 that is in communication with an evolved packet core (“EPC”) 104 via an evolved Universal Mobile Telecommunications System Terrestrial Radio Access Network (“E-UTRAN”) 106. In the illustrated embodiment, the EPC 104 includes a traffic distribution system 108. Alternatively, the EPC 104 can be in communication with the traffic distribution system 108. The illustrated EPC 104 also includes one or more EPC functions 110.

The traffic distribution system 108 can communicate with a plurality of sites 112A-112C (hereinafter collectively referred to as “sites 112”). Each of the sites 112 includes a virtual call session control function (“V-CSCF”) 114 and a state persistence database 116. In particular, the site A 112A includes a V-CSCF A 114A and a state persistence database A 116A, the site B 112B includes a V-CSCF B 114B and a state persistence database B 116B, and a site C 112C includes a V-CSCF C 114C and a state persistence database C 116C. Although three sites are illustrated, at least two sites may alternatively be used, and as such, the illustrated embodiment should not be construed as being limiting in any way.

The device 102 can be a mobile telephone, a smartphone, a mobile computer, a tablet computer, or any other user equipment (“UE”) that is configured to communicate with the EPC 104 via the E-UTRAN 106. As such, the device 102 can include at least one transceiver that is compatible with Long-Term Evolution (“LTE”) to enable communications with the E-UTRAN 106. The device 102 can include one or more other transceivers to enable communications with other access networks including, but not limited to, access networks that operate in accordance with Global System for Mobile communications (“GSM”), Code Division Multiple Access (“CDMA”) ONE, CDMA2000, and various other Third Generation Partnership Project (“3GPP”). Moreover, the other transceiver(s) may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiplexing (“OFDM”), Space-Division Multiple Access (“SDMA”), and the like. The device also can include one or more transceivers to enable communications with WI-MAX and/or WI-FI networks.

The traffic distribution system 108 of the EPC 104 can receive connection requests from the device 102 and other devices (not shown) and can send the connection requests to one of the sites 112, and more particularly, to one of the V-CSCFs 114 operating within the sites 112. For example, the device 102 can send a connection request to the V-CSCF A 114A operating within the site A 112A. The V-CSCF A 114A, in turn, can register the device 102 and store a registration state 118 associated with the device 102 in the state persistence database A 116A.

The state persistence database A 116A can replicate the registration state 118 to state persistence databases operating within any number of sites. In the illustrated example, the state persistence database A 116A replicates the registration state 118 to the state persistence database B 116B operating within the site B 112B and the state persistence database C 116C operating within the site C 112C. In some embodiments, the state persistence databases 116 operate using a cloud-based state persistence service that utilizes a cloud-based data store or database. In some embodiments, the state persistence databases 115 may be or may include NoSQL database such as, for example, CASSANDRA available from THE APACHE SOFTWARE FOUNDATION. In some other embodiments, the state persistence databases 116 operate, at least in part, by providing a caching solution such as MEMCACHED. In this manner, the registration state 118 is replicated across a set of disaster recovery sites by a database tier and is available at those sites. In case of a site failure, user devices can continue being registered with the serving network since the registration state is available at the disaster recovery sites. Also, devices do not need to re-publish presence information as the presence information is available at the disaster recovery sites.

The traffic distribution system 108 also can monitor the sites 112 and can detect when one or more of the sites 112 has failed. If the site to which the traffic distribution system 108 sent a connection request fails, the traffic distribution system 108 can detect the failure and send any incoming session requests to another site. For example, after detecting that the site A 112A has failed, the traffic distribution system 108 can direct any session requests received from the device 102 to the site B 112B or the site C 112C in which the registration state 118 is also stored.

The EPC functions 110 of the EPC 104 can include a serving gateway, a packet data network (“PDN”) gateway, a mobility management entity (“MME”), and a home subscriber server (“HSS”). The serving gateway can transport Internet Protocol (“IP”) data traffic between the device 102 and one or more external networks, including, an IP multimedia subsystem (“IMS”) network that includes the sites 112. The serving gateway connects the E-UTRAN 106 to the EPC 104 to allow IP data communication between the device 102 and the EPC 104. The serving gateway also performs operations to facilitate handover among eNodeBs (not shown) within the E-UTRAN 106 and between other LTE and 3GPP access networks. The serving gateway is in communication with the PDN gateway.

The PDN gateway interconnects the EPC 104 and external IP networks (i.e., PDNs—not shown). The PDN gateway routes IP packets to and from the PDNs. The PDN gateway also performs operations such as IP address/IP prefix allocation, policy control, and charging. In some implementations, the PDN gateway and the serving gateway are combined.

The MME performs signal handling operation related to mobility and security for access to the E-UTRAN 106. The MME can track and page the device 102 when the device 102 is in idle mode.

The HSS is a database that contains user/subscriber information. The HSS also performs operations to support mobility management, call and session setup, user authentication, and access authorization.

The V-CSCFs 114 can perform operations regarding session establishment and teardown, user authentication, security, and Quality of Service (“QoS”) for IP-based communications and services. The V-CSCFs 114 can be or can include virtual abstractions of one or more physical CSCFs, including, for example, a proxy-CSCF (“P-CSCF”), an interrogating-CSCF (“I-CSCF”), a serving-CSCF (“S-CSCF”), or a combination thereof. The V-CSCFs 114 can operate on hardware resources 120, including one or more compute resources 122, one or more memory resources 124, and one or more other resources 126. The hardware resources 120 can be co-located or distributed across a number of locations.

A P-CSCF can provide a first point of contact between the device 102 and other devices (not shown) and an IMS network. A P-CSCF can validate SIP messages with exchanged between the devices and the IMS network according to SIP standards. A P-CSCF can provide security for SIP messages exchanged between the devices and the IMS network using IPsec and transport layer security (“TLS”), for example. A P-CSCF can authenticate the identity of devices. A P-CSCF can compress SIP messages to ensure efficient transmission over narrowband channels and to conserve bandwidth. The P-CSCF can provide policy enforcement functions. A P-CSCF can generate charging information for sessions. A P-CSCF can perform other operations as will be appreciated by those skilled in the art.

An I-CSCF can provide an entry point for all connections related to users, such as a user associated with the device 102. An I-CSCF can identify the S-SCSF for a given user performing SIP registration and can forward the connection request to the appropriate S-CSCF. An I-CSCF can implement a Diameter (RFC 3588) interface to an HSS, and can query the HSS to retrieve the address of the S-CSCF for devices to perform SIP registration. An I-CSCF can forward SIP message requests and responses to the S-CSCF. An I-CSCF can encrypt SIP messages or portions thereof.

A S-CSCF can provide signaling functions for the IMS network. A S-CSCF can perform location registration, user authentication, and call/session routing and processing operations. A S-CSCF can support Diameter interfaces to the HSS over which to download authentication information and user profile of registering devices from the HSS for authentication. SIP signaling to and from devices can traverse the S-CSCF that is allocated during device registration.

The compute resource(s) 122 can include one or more hardware components that perform computations to process data, and/or to execute computer-executable instructions of one or more application programs, operating systems, and/or other software. The compute resources 122 can include one or more central processing units (“CPUs”) configured with one or more processing cores. The compute resources 122 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 122 can include one or more discrete GPUs. In some other embodiments, the compute resources 122 can include CPU and GPU components that are configured in accordance with a co-processing CPU/GPU computing model, wherein the sequential part of an application executes on the CPU and the computationally-intensive part is accelerated by the GPU. The compute resources 122 can include one or more system-on-chip (“SoC”) components along with one or more other components, including, for example, one or more of the memory resources 124, and/or one or more of the other resources 126. In some embodiments, the compute resources 122 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 122 can be or can include one or more hardware components architected in accordance with an ARM architecture, available for license from ARM HOLDINGS of Cambridge, United Kingdom. Alternatively, the compute resources 122 can be or can include one or more hardware components architected in accordance with an x86 architecture, such an architecture available from INTEL CORPORATION of Mountain View, Calif., and others. Those skilled in the art will appreciate the implementation of the compute resources 122 can utilize various computation architectures, and as such, the compute resources 122 should not be construed as being limited to any particular computation architecture or combination of computation architectures, including those explicitly disclosed herein.

The memory resource(s) 124 can include one or more hardware components that perform storage operations, including temporary or permanent storage operations. In some embodiments, the memory resource(s) 124 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 122.

The other resource(s) 126 can include any other hardware resources that can be utilized by the compute resources(s) 122 and/or the memory resource(s) 124 to perform operations described herein. The other resource(s) 126 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources 120 can be virtualized by one or more virtual machine monitors (not shown), also known as hypervisors, to create the V-CSCFs 114. The virtual machine monitors can be or can include software, firmware, and/or hardware that alone or in combination with other software, firmware, and/or hardware, creates the V-CSCFs 114.

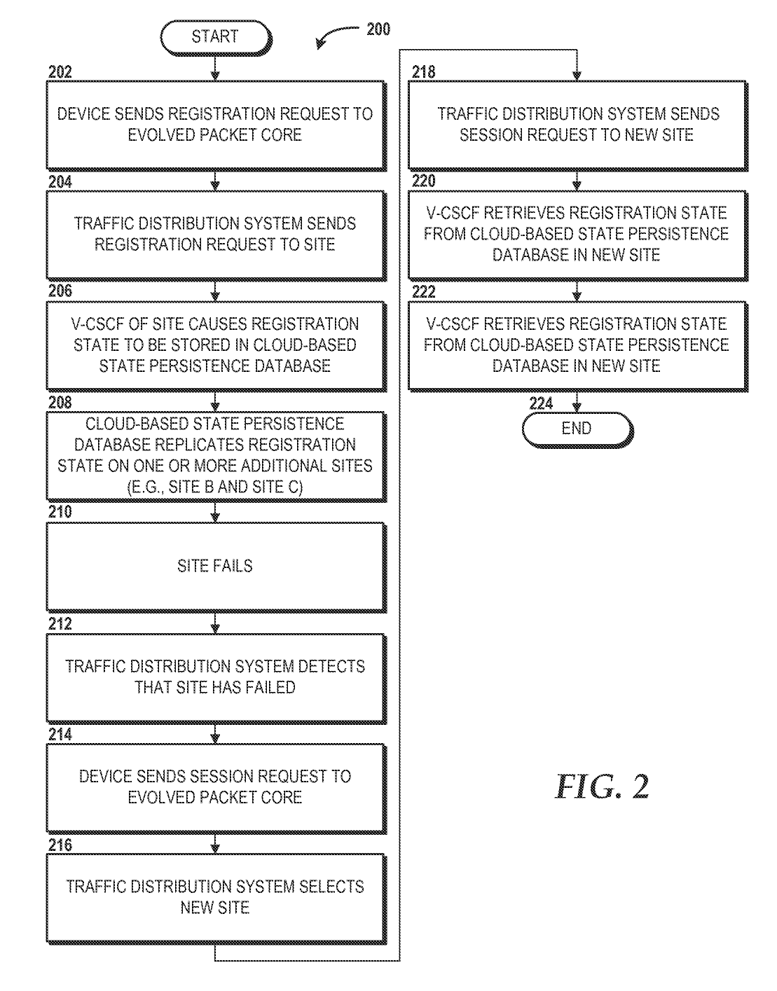

Turning now to FIG. 2, aspects of a method 200 for avoiding registration storms for OSI communication model layer 4 through layer 7 services in a cloud computing system will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of one or more other computing systems, devices, engines, or components disclosed herein to perform operations. It should be understood that the performance of one or more operations may include operations executed by one or more virtual processors at the instructions of one or more of the aforementioned hardware processors.

The method 200 will be described with reference to FIG. 2 and further reference to FIG. 1. The method 200 begins at operation 202, where the device 102 sends a connection request to the EPC 104 via the E-UTRAN 106. From operation 202, the method 200 proceeds to operation 204, where the traffic distribution system 108 receives the connection request and sends the connection request to one of the sites 112, which in the illustrated embodiment, is the site A 112A.

From operation 204, the method 200 proceeds to operation 206, where the V-CSCF A 114A of the site A 112A causes the registration state 118 associated with the device 102 to be stored in the state persistence database A 116A. From operation 206, the method 200 proceeds to operation 208, where the state persistence database A 116A replicates the registration state 118 to one or more additional sites, such as, in the example shown in FIG. 1, to the site B 112B and to the site C 112C. It should be understood that registration states can be replicated to any number of databases, and as such, the example illustrated and described with reference to FIGS. 1 and 2 should not be construed as being limited in any way.

From operation 208, the method 200 proceeds to operation 210, where the site A 112A fails. From operation 210, the method 200 proceeds to operation 212, where the traffic distribution system 108 detects that the site A 112A has failed.

From operation 212, the method 200 proceeds to operation 214, where the device 102 sends a session request to the EPC 104. The session request can include a request to create a session for any OSI layer 4-7 service, some examples of which include, but are not limited to, voice over LTE (“VoLTE”) and video communications. From operation 214, the method 200 proceeds to operation 216, where the traffic distribution system 108 selects a new site, such as the site B 112B. From operation 216, the method 200 proceeds to operation 218, where the traffic distribution system 108 sends the session request to the V-CSCF 114 operating within the new site, such as the V-CSCF 114B operating within the site B 112B.

From operation 218, the method 200 proceeds to operation 220, where the V-CSCF 114 retrieves the registration state 118 from the state persistence database 116 operating within the new site, such as the state persistence database 116B operating within the site B 112B. From operation 220, the method 200 proceeds to operation 222, where the V-CSCF 114 processes the session request.

From operation 222, the method 200 proceeds to operation 224. The method 200 ends at operation 224.

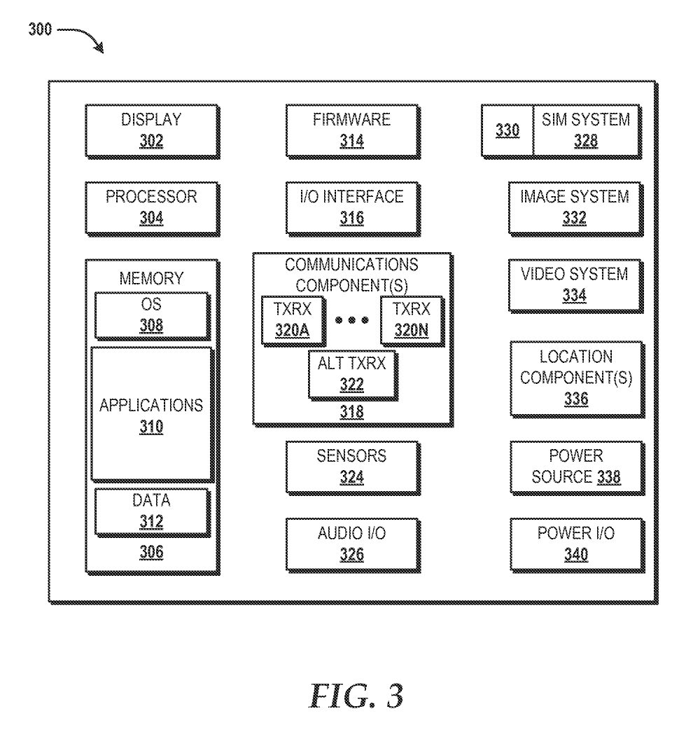

Turning now to FIG. 3, an illustrative mobile device 300 and components thereof will be described, according to one embodiment. The device 102 may be configured like or have an architecture similar to the mobile device 300. While connections are not shown between the various components illustrated in FIG. 3, it should be understood that some, none, or all of the components illustrated in FIG. 3 can be configured to interact with one other to carry out various device functions. In some embodiments, the components are arranged so as to communicate via one or more busses (not shown). Thus, it should be understood that FIG. 3 and the following description are intended to provide a general understanding of a suitable environment in which various aspects of embodiments can be implemented, and should not be construed as being limiting in any way.

As illustrated in FIG. 3, the mobile device 300 can include a display 302 for displaying data. According to various embodiments, the display 302 can be configured to display various graphical user interface (“GUI”) elements, text, images, video, virtual keypads and/or keyboards, messaging data, notification messages, metadata, internet content, device status, time, date, calendar data, device preferences, map and location data, combinations thereof, and/or the like. The mobile device 300 also can include a processor 304 and a memory or other data storage device (“memory”) 306. The processor 304 can be configured to process data and/or can execute computer-executable instructions stored in the memory 306. The computer-executable instructions executed by the processor 304 can include, for example, an operating system 308, one or more applications 310, other computer-executable instructions stored in a memory 308, or the like. In some embodiments, the applications 310 also can include a user interface (“UI”) application (not illustrated in FIG. 3).

The UI application can interface with the operating system 308 to facilitate user interaction with functionality and/or data stored at the mobile device 300 and/or stored elsewhere. In some embodiments, the operating system 308 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 304 to aid a user in entering content, viewing account information, answering/initiating calls, entering/deleting data, entering and setting user IDs and passwords for device access, configuring settings, manipulating address book content and/or settings, multimode interaction, interacting with other applications 310, and otherwise facilitating user interaction with the operating system 308, the applications 310, and/or other types or instances of data 312 that can be stored at the mobile device 300. The data 312 can include, for example, one or more identifiers, and/or other applications or program modules. According to various embodiments, the data 312 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 310, the data 312, and/or portions thereof can be stored in the memory 306 and/or in a firmware 314, and can be executed by the processor 304. The firmware 314 also can store code for execution during device power up and power down operations. It can be appreciated that the firmware 313 can be stored in a volatile or non-volatile data storage device including, but not limited to, the memory 306 and/or a portion thereof.

The mobile device 300 also can include an input/output (“I/O”) interface 316. The I/O interface 316 can be configured to support the input/output of data such as location information, user information, organization information, presence status information, user IDs, passwords, and application initiation (start-up) requests. In some embodiments, the I/O interface 316 can include a hardwire connection such as USB port, a mini-USB port, a micro-USB port, an audio jack, a PS2 port, an IEEE 1333 (“FIREWIRE”) port, a serial port, a parallel port, an Ethernet (RJ35) port, an RJ10 port, a proprietary port, combinations thereof, or the like. In some embodiments, the mobile device 300 can be configured to synchronize with another device to transfer content to and/or from the mobile device 300. In some embodiments, the mobile device 300 can be configured to receive updates to one or more of the applications 310 via the I/O interface 316, though this is not necessarily the case. In some embodiments, the I/O interface 316 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 316 may be used for communications between the mobile device 300 and a network device or local device.

The mobile device 300 also can include a communications component 318. The communications component 318 can be configured to interface with the processor 304 to facilitate wired and/or wireless communications with one or more networks such as one or more IP access networks and/or one or more circuit access networks. In some embodiments, other networks include networks that utilize non-cellular wireless technologies such as WI-FI or WIMAX. In some embodiments, the communications component 318 includes a multimode communications subsystem for facilitating communications via the cellular network and one or more other networks.

The communications component 318, in some embodiments, includes one or more transceivers. The one or more transceivers, if included, can be configured to communicate over the same and/or different wireless technology standards with respect to one another. For example, in some embodiments one or more of the transceivers of the communications component 318 may be configured to communicate using Global System for Mobile communications (“GSM”), Code Division Multiple Access (“CDMA”) ONE, CDMA2000, Long-Term Evolution (“LTE”), and various other 2G, 2.5G, 3G, 3G, and greater generation technology standards. Moreover, the communications component 318 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiplexing (“OFDM”), Space-Division Multiple Access (“SDMA”), and the like.

In addition, the communications component 318 may facilitate data communications using Generic Packet Radio Service (“GPRS”), Enhanced Data Rates for Global Evolution (“EDGE”), the High-Speed Packet Access (“HSPA”) protocol family including High-Speed Download Packet Access (“HSDPA”), Enhanced Uplink (“EUL”) or otherwise termed High-Speed Upload Packet Access (“HSUPA”), HSPA+, and various other current and future wireless data access standards. In the illustrated embodiment, the communications component 318 can include a first transceiver (“TxRx”) 320A that can operate in a first communications mode (e.g., GSM). The communications component 318 also can include an N^{th} transceiver (“TxRx”) 320N that can operate in a second communications mode relative to the first transceiver 320A (e.g., UMTS). While two transceivers 320A-320N (hereinafter collectively and/or generically referred to as “transceivers 320”) are shown in FIG. 3, it should be appreciated that less than two, two, and/or more than two transceivers 320 can be included in the communications component 318.

The communications component 318 also can include an alternative transceiver (“Alt TxRx”) 322 for supporting other types and/or standards of communications. According to various contemplated embodiments, the alternative transceiver 322 can communicate using various communications technologies such as, for example, WI-FI, WIMAX, BLUETOOTH, infrared, infrared data association (“IRDA”), near-field communications (“NFC”), other radio frequency (“RF”) technologies, combinations thereof, and the like.

In some embodiments, the communications component 318 also can facilitate reception from terrestrial radio networks, digital satellite radio networks, internet-based radio service networks, combinations thereof, and the like. The communications component 318 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 300 also can include one or more sensors 323. The sensors 323 can include temperature sensors, light sensors, air quality sensors, movement sensors, orientation sensors, noise sensors, proximity sensors, or the like. As such, it should be understood that the sensors 324 can include, but are not limited to, accelerometers, magnetometers, gyroscopes, infrared sensors, noise sensors, microphones, combinations thereof, or the like. Additionally, audio capabilities for the mobile device 300 may be provided by an audio I/O component 326. The audio I/O component 326 of the mobile device 300 can include one or more speakers for the output of audio signals, one or more microphones for the collection and/or input of audio signals, and/or other audio input and/or output devices.

The illustrated mobile device 300 also can include a subscriber identity module (“SIM”) system 328. The SIM system 328 can include a universal SIM (“USIM”), a universal integrated circuit card (“UICC”) and/or other identity devices. The SIM system 328 can include and/or can be connected to or inserted into an interface such as a slot interface 330. In some embodiments, the slot interface 330 can be configured to accept insertion of other identity cards or modules for accessing various types of networks. Additionally, or alternatively, the slot interface 330 can be configured to accept multiple subscriber identity cards. Because other devices and/or modules for identifying users and/or the mobile device 300 are contemplated, it should be understood that these embodiments are illustrative, and should not be construed as being limiting in any way.

The mobile device 300 also can include an image capture and processing system 332 (“image system”). The image system 332 can be configured to capture or otherwise obtain photos, videos, and/or other visual information. As such, the image system 332 can include cameras, lenses, charge-coupled devices (“CCDs”), combinations thereof, or the like. The mobile device 300 may also include a video system 334. The video system 334 can be configured to capture, process, record, modify, and/or store video content. Photos and videos obtained using the image system 332 and the video system 334, respectively, may be added as message content to an MMS message, email message, and sent to another mobile device. The video and/or photo content also can be shared with other devices via various types of data transfers via wired and/or wireless communication devices as described herein.

The mobile device 300 also can include one or more location components 336. The location components 336 can be configured to send and/or receive signals to determine a geographic location of the mobile device 300. According to various embodiments, the location components 336 can send and/or receive signals from global positioning system (“GPS”) devices, assisted GPS (“A-GPS”) devices, WI-FI/WIMAX and/or cellular network triangulation data, combinations thereof, and the like. The location component 336 also can be configured to communicate with the communications component 318 to retrieve triangulation data for determining a location of the mobile device 300. In some embodiments, the location component 336 can interface with cellular network nodes, telephone lines, satellites, location transmitters and/or beacons, wireless network transmitters and receivers, combinations thereof, and the like. In some embodiments, the location component 336 can include and/or can communicate with one or more of the sensors 323 such as a compass, an accelerometer, and/or a gyroscope to determine the orientation of the mobile device 300. Using the location component 336, the mobile device 300 can generate and/or receive data to identify its geographic location, or to transmit data used by other devices to determine the location of the mobile device 300. The location component 336 may include multiple components for determining the location and/or orientation of the mobile device 300.

The illustrated mobile device 300 also can include a power source 338. The power source 338 can include one or more batteries, power supplies, power cells, and/or other power subsystems including alternating current (“AC”) and/or direct current (“DC”) power devices. The power source 338 also can interface with an external power system or charging equipment via a power I/O component 330. Because the mobile device 300 can include additional and/or alternative components, the above embodiment should be understood as being illustrative of one possible operating environment for various embodiments of the concepts and technologies described herein. The described embodiment of the mobile device 300 is illustrative, and should not be construed as being limiting in any way.

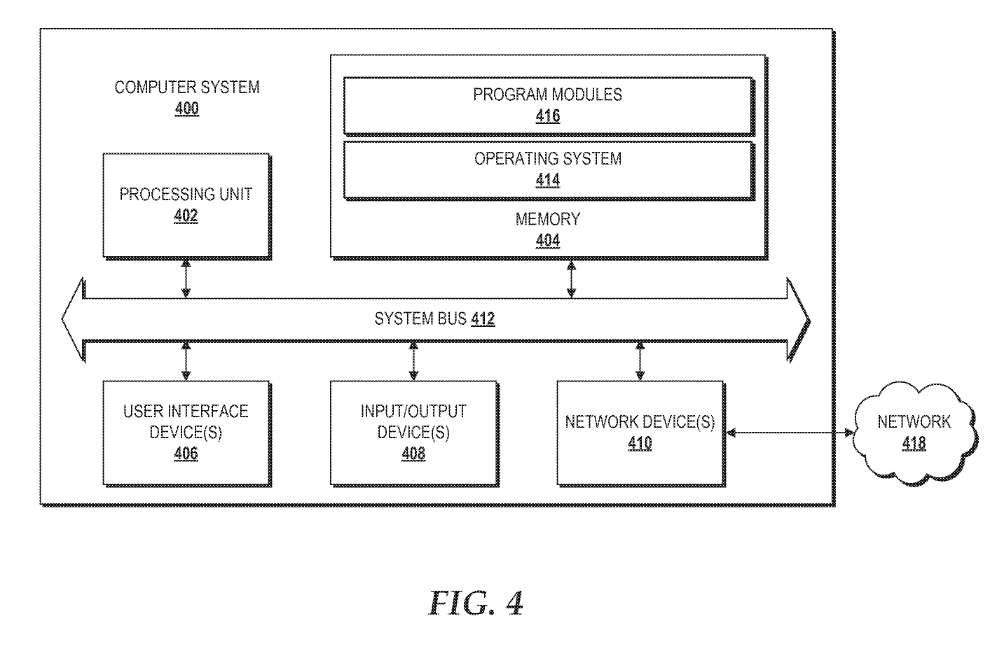

FIG. 4 is a block diagram illustrating a computer system 400 configured to provide the functionality in accordance with various embodiments of the concepts and technologies disclosed herein. In some implementations, the hardware resources 120 (illustrated in FIG. 1) includes one or more computers that are configured like the architecture of the computer system 400. The computer system 400 may provide at least a portion of the compute resources 122, the memory resources 124, and/or the other resources 126. It should be understood, however, that modification to the architecture may be made to facilitate certain interactions among elements described herein.

The computer system 400 includes a processing unit 402, a memory 404, one or more user interface devices 406, one or more input/output (“I/O”) devices 408, and one or more network devices 410, each of which is operatively connected to a system bus 412. The bus 412 enables bi-directional communication between the processing unit 402, the memory 404, the user interface devices 406, the I/O devices 408, and the network devices 410.

The processing unit 402 may be a standard central processor that performs arithmetic and logical operations, a more specific purpose programmable logic controller (“PLC”), a programmable gate array, or other type of processor known to those skilled in the art and suitable for controlling the operation of the server computer. Processing units are generally known, and therefore are not described in further detail herein. The compute resources 122 (illustrated in FIG. 1) can include one or more processing units 402.

The memory 404 communicates with the processing unit 402 via the system bus 412. In some embodiments, the memory 404 is operatively connected to a memory controller (not shown) that enables communication with the processing unit 402 via the system bus 412. The memory resources 124 can include one or more instances of the memory 404. The illustrated memory 404 includes an operating system 414 and one or more program modules 416. The operating system 414 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, OS X, and/or iOS families of operating systems from APPLE CORPORATION, the FREEBSD family of operating systems, the SOLARIS family of operating systems from ORACLE CORPORATION, other operating systems, and the like.

The program modules 416 may include various software and/or program modules to perform the various operations described herein. The program modules 416 and/or other programs can be embodied in computer-readable media containing instructions that, when executed by the processing unit 402, perform various operations such as those described herein. According to embodiments, the program modules 416 may be embodied in hardware, software, firmware, or any combination thereof.

By way of example, and not limitation, computer-readable media may include any available computer storage media or communication media that can be accessed by the computer system 400. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 400. In the claims, the phrase “computer storage medium” and variations thereof does not include waves or signals per se and/or communication media.

The user interface devices 406 may include one or more devices with which a user accesses the computer system 400. The user interface devices 406 may include, but are not limited to, computers, servers, PDAs, cellular phones, or any suitable computing devices. The I/O devices 408 enable a user to interface with the program modules 416. In one embodiment, the I/O devices 408 are operatively connected to an I/O controller (not shown) that enables communication with the processing unit 402 via the system bus 412. The I/O devices 408 may include one or more input devices, such as, but not limited to, a keyboard, a mouse, or an electronic stylus. Further, the I/O devices 408 may include one or more output devices, such as, but not limited to, a display screen or a printer. In some embodiments, the I/O devices 408 can be used for manual controls for operations to exercise under certain emergency situations.

The network devices 410 enable the computer system 400 to communicate with other networks or remote systems via a network 418. Examples of the network devices 418 include, but are not limited to, a modem, a radio frequency (“RF”) or infrared (“IR”) transceiver, a telephonic interface, a bridge, a router, or a network card. The network 414 may include a wireless network such as, but not limited to, a Wireless Local Area Network (“WLAN”), a Wireless Wide Area Network (“WWAN”), a Wireless Personal Area Network (“WPAN”) such as provided via BLUETOOTH technology, a Wireless Metropolitan Area Network (“WMAN”) such as a WiMAX network or metropolitan cellular network. Alternatively, the network 414 may be a wired network such as, but not limited to, a Wide Area Network (“WAN”), a wired Personal Area Network (“PAN”), or a wired Metropolitan Area Network (“MAN”). The network 418 may be any other network described herein.

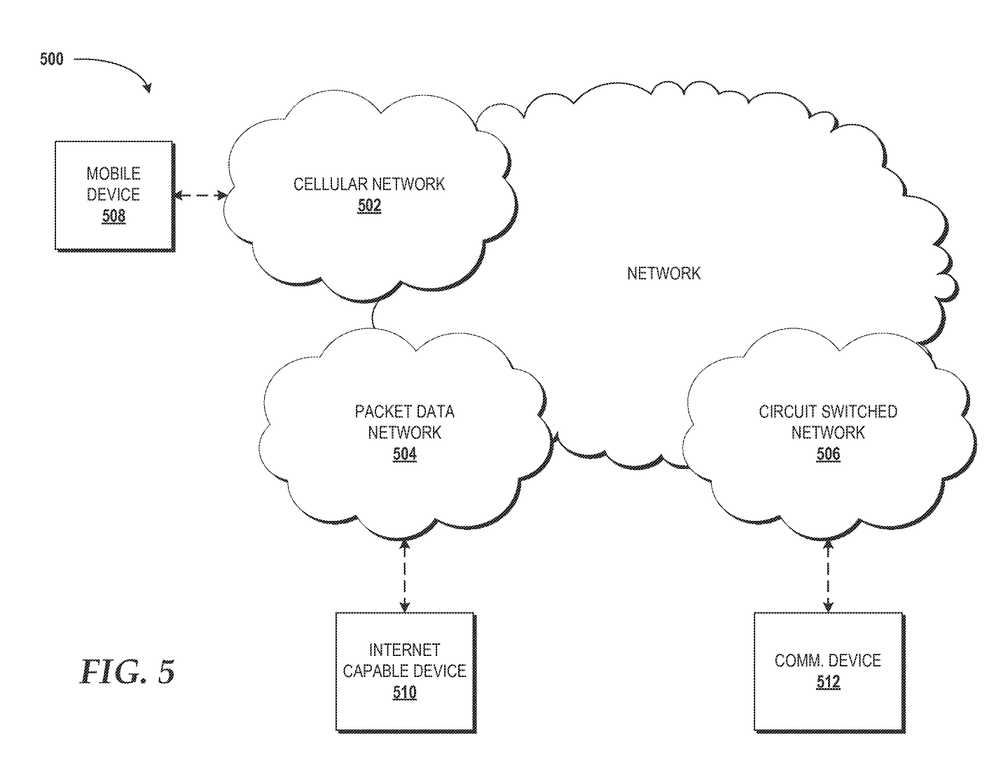

Turning now to FIG. 5, details of a network 500 are illustrated, according to an illustrative embodiment. The network 500 can include the EPC 104, the E-UTRAN 106, and the sites 112 described above with reference to FIG. 1. The illustrated network 500 includes a cellular network 502, a packet data network 504, for example, the Internet, and a circuit switched network 506, for example, a PSTN. The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 also is compatible with 4G mobile communications standards such as LTE, or the like, as well as evolved and future mobile standards.

The packet data network 504 includes various devices, for example, servers, computers, databases, and other devices in communication with another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a POTS. The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, the unmanaged TDM device, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. It should be appreciated that substantially all of the functionality described with reference to the network 120 can be performed by the cellular network 502, the packet data network 504, and/or the circuit switched network 506, alone or in combination with other networks, network elements, and the like.

Based on the foregoing, it should be appreciated that concepts and technologies directed to avoiding registration storms for OSI communication model layers 4-7 services in a cloud computing system have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

We claim:

1. A traffic distribution system comprising:
a processor; and
a memory that stores instructions that, when executed by the processor, cause the processor to perform operations comprising:
receiving a connection request from a device, and
sending the connection request to a site that comprises a virtual call session control function and a state persistence database, wherein the virtual call session control function causes a registration state associated with the device to be stored in the state persistence database, and wherein the registration state is replicated to a further state persistence database operating within a further site.

2. The traffic distribution system of claim 1, wherein receiving the connection request from the device comprises receiving the connection request from the device via an evolved packet core.

3. The traffic distribution system of claim 2, wherein the processor resides within the evolved packet core.

4. The traffic distribution system of claim 2, wherein the processor is in communication with the evolved packet core.

5. The traffic distribution system of claim 1, wherein the operations further comprise:
detecting that the site has failed;
receiving a session request from the device; and
in response to receiving the session request after the site has failed, sending the session request to a further virtual call session control function that operates within the further site.

6. The traffic distribution system of claim 5, wherein detecting that the site has failed comprises detecting that the site has received a number of connection requests beyond a threshold number of connection requests that the site is capable of handling.

7. The traffic distribution system of claim 5, wherein the session request is for a service that operates within service operates within at least one of layer 4 through layer 7 of the Open Systems Interconnection communication model.

8. A cloud computing system comprising:
a traffic distribution system that performs operations comprising:
receiving a connection request from a device, and
sending the connection request to a first site; and
the first site comprising
a first state persistence database, and
a first virtual call session control function that performs operations comprising
causing a registration state associated with the device to be stored in the first state persistence database, and
replicating the registration state to a second state persistence database of a second site.

9. The cloud computing system of claim 8, wherein receiving, by the traffic distribution system, the connection request from the device comprises receiving, by the traffic distribution system, the connection request from the device via an evolved packet core.

10. The cloud computing system of claim 8, wherein the traffic distribution system performs further operations comprising:
detecting that the first site has failed;
receiving a session request from the device; and
in response to receiving the session request after the site has failed, sending the session request to a second virtual call session control function of the second site.

11. The cloud computing system of claim 10, wherein detecting, by the traffic distribution system, that the first site has failed comprises detecting, by the traffic distribution system, that the site has received a number of connection requests beyond a threshold number of connection requests that the first site is capable of handling.

12. The cloud computing system of claim 10, wherein the session request is for a service that operates within service operates within at least one of layer 4 through layer 7 of the Open Systems Interconnection communication model.

13. The cloud computing system of claim 8, further comprising a second site, the second site comprising a second virtual call session control function, and a second state persistence database; and wherein the first state persistence database performs further operations comprising replicating the registration state to the second state persistence database.

14. A method comprising:
receiving, by a traffic distribution system that comprises a processor, a connection request from a device; and
sending, by the traffic distribution system, the connection request to a site that comprises a virtual call session control function and a state persistence database, wherein the virtual call session control function causes a registration state associated with the device to be stored in the state persistence database, and wherein the registration state is replicated to a further state persistence database operating within a further site.

15. The method of claim 14, wherein receiving the connection request from the device comprises receiving the connection request from the device via an evolved packet core.

16. The method of claim 15, wherein the traffic distribution system resides within the evolved packet core.

17. The method of claim 15, wherein the traffic distribution system is in communication with the evolved packet core.

18. The method of claim 14, further comprising:
detecting, by the traffic distribution system, that the site has failed;
receiving, by the traffic distribution system, a session request from the device; and
in response to receiving the session request after the site has failed, sending, by the traffic distribution system, the session request to a further virtual call session control function that operates within the further site.

19. The method of claim 18, wherein detecting, by the traffic distribution system, that the site has failed comprises detecting, by the traffic distribution system, that the site has received a number of connection requests beyond a threshold number of connection requests that the site is capable of handling.

20. The method of claim 18, wherein the session request is for a service that operates within service operates within at least one of layer 4 through layer 7 of the Open Systems Interconnection communication model.
